(19) United States
(12) Patent Application Publication
(10) Pub. No.: US 2010/0332240 A1
(43) Pub. Date: Dec. 30, 2010

(54) DECENTRALIZED ACCOUNT DIGEST USING SIGNED ELECTRONIC RECEIPTS

(75) Inventors: Henry Hooper Somuah, Seattle, WA (US); Scott J. Fierstein, Seattle, WA (US); Robert Kilroy Hughes, JR., Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/490,328

(22) Filed: Jun. 24, 2009

(51) Int. Cl. G06Q 30/00

(52) U.S. Cl. 705/1.1

(57) ABSTRACT

Decentralized storage of electronic receipts for sharing transaction histories. Merchants generate and digitally sign the electronic receipts for transactions involving electronic content products. The electronic receipts for a user are stored by the user. The user later presents other entities with the electronic receipt as proof of the transaction. The merchants also maintain “graveyard lists,” or lists of cancelled transactions that are used by other merchants to determine whether a particular transaction is still valid. For example, if the electronic content product associated with the particular transaction has been returned or exchanged, the particular transaction is added to the list of cancelled transactions.

### BACKGROUND

Proving ownership of a physical good is often accomplished through possession of the physical good. It is more difficult, however, to prove ownership of digital content such as music, video, and images. In existing systems, merchants provide receipts to users who purchase the digital content. At least because of the ease by which the receipts may be fraudulently altered or created, merchants generally do not trust receipts provided by users that relate to transactions with other merchants. As a result, some existing systems focus on establishing trust between merchants to validate the electronic receipts. Such existing trust systems, however, exclude the user, only include participating merchants, and do not address scenarios in which one of the merchants becomes unavailable or stops participating in the trust system.

### SUMMARY

Embodiments of the invention enable a decentralized account digest. Merchants generate and digitally sign electronic receipts responsive to transactions with users involving electronic content products. The merchants further maintain a list of cancelled transactions between the users and the merchants. The merchants provide the list of cancelled transactions for access by other merchants to enable verification and validation services.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a plurality of users interacting with a plurality of merchants for transactions related to digital content products.

FIG. 2 is an exemplary block diagram illustrating a merchant computing device.

FIG. 3 is an exemplary block diagram illustrating a third-party publication service providing an aggregated list of transactions.

FIG. 4 is an exemplary flow chart illustrating the generation of digitally signed electronic receipts for transactions.

FIG. 5 is an exemplary flow chart illustrating the maintenance and publication of a list of cancelled transactions.

Corresponding reference characters indicate corresponding parts throughout the drawings.

### DETAILED DESCRIPTION

Referring to the figures, embodiments of the disclosure enable, at least, the decentralized storage and use of transaction records in a non-repudiable manner. The transaction records represent a history of transactions between users 104 and merchants 102. By decentralizing the storage, aspects of the disclosure remove the central point of failure, promote high-availability, provide scale, and improve the social experience between the users 104 and the merchants 102. With the disclosure, the transaction records are shareable between interested parties without a risk of data tampering.

Some embodiments of the disclosure are implemented using decentralized synchronization in which the transactions are represented as feeds or lists of items. In such embodiments, the transaction histories are synchronized between multiple parties in a bi-directional, asymmetric manner. Proof-of-purchase is possible even if the merchant 102 involved in the transaction is no longer available. Further, by digitally signing the individual entries in the feeds, synchronization protocols are used to merge documents from multiple merchants 102 into a single receipt booklet (e.g., stored by each of the users 104).

In some embodiments, the decentralized synchronization is implemented as a mesh computing model. However, aspects of the disclosure may be implemented with other technology. That is, the disclosure is not limited to mesh technologies.

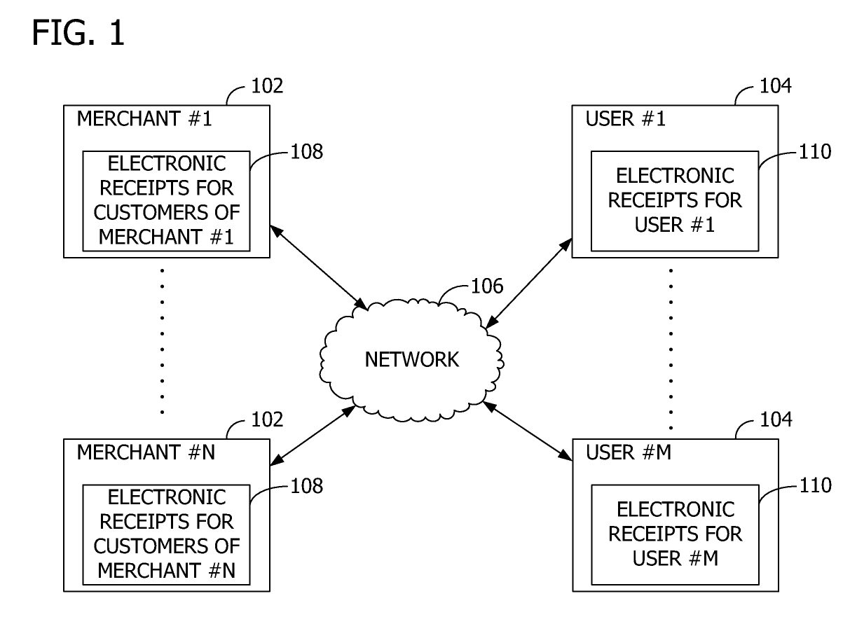

Referring again to FIG. 1, an exemplary block diagram illustrates a plurality of the users 104 interacting with a plurality of the merchants 102 for transactions. The users 104, such as user #1 through user #M, communicate with the merchants 102, such as merchant #1 through merchant #N, via a network 106. The transactions relate, for example, to the purchase or rental of digital content products. The digital content products include one or more of the following: an electronic document, audio data, video data, still image data, and the like.

Each of the merchants 102 stores electronic receipts 108 relating to transactions associated with that merchant 102 and one or more of the users 104. For example, merchant #1 stores the electronic receipts 108 relating to transactions associated with merchant #1. The electronic receipts 108 may be organized as a digital receipt list for each of the users 104 listing purchases from that user 104.

Each of the users 104 stores electronic receipts 110 relating to transactions associated with that user 104 and one or more of the merchants 102. For example, user #1 stores the electronic receipts 110 relating to transactions associated with user #1. The electronic receipts 110 stored by the user 104 constitute a digital receipt booklet.

The merchants 102 and the users 104 may store additional information or metadata about the transactions such as, for example, user information, preferences, and previous transaction history.

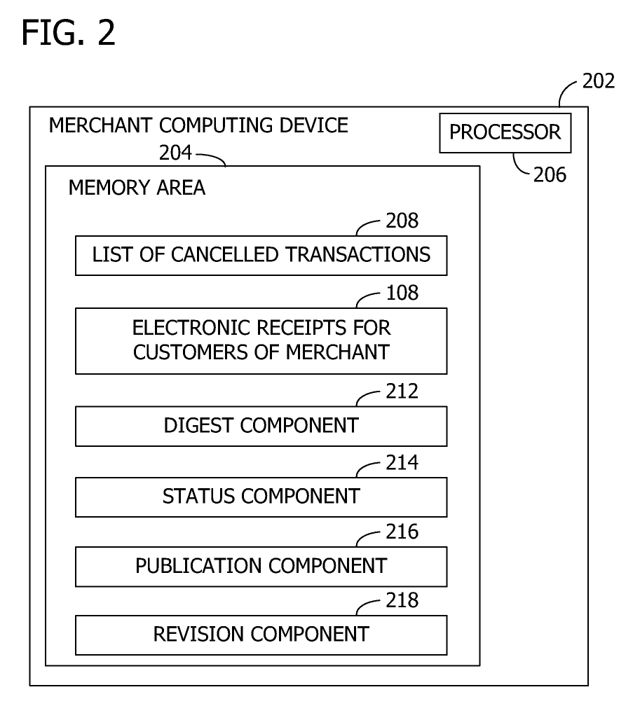

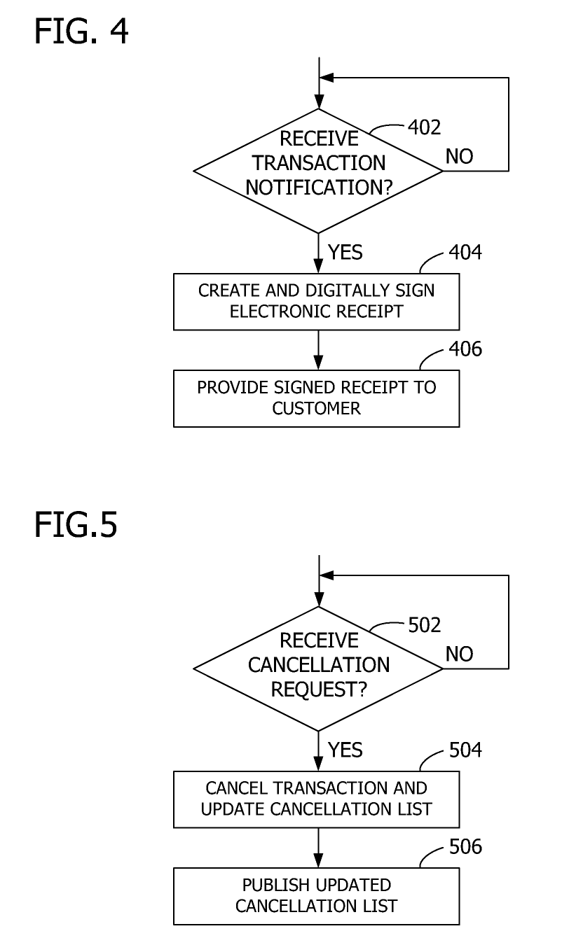

Referring next to FIG. 2, an exemplary block diagram illustrates a merchant computing device 202. The merchant computing device 202 includes at least a processor 206 and a memory area 204. The processor 206 includes any quantity of processing units, and is programmed to execute computer-executable instructions for implementing aspects of the disclosure. The instructions may be performed by the processor 206 or by multiple processors executing within the merchant computing device 202, or performed by a processor external to the merchant computing device 202. In some embodiments, the processor 206 is programmed to execute instructions such as those illustrated in the figures (e.g., FIG. 4 and FIG. 5).

The memory area 204, or other computer-readable media, stores the list of cancelled transactions 208. In some embodiments, the list of cancelled transactions 208 includes those transactions in which the merchant 102 associated with the merchant computing device 202 is involved. In other embodiments, the list of cancelled transactions 208 is an aggregated list of cancelled transactions 304 including transactions from other merchants 102. The list of cancelled transactions 208 is considered a graveyard feed identifying transactions (e.g., tombstone entries) that are no longer valid for some reason (e.g., the digital content product or item was returned for a refund or exchanged, or was a fraudulent transaction).

The memory area 204 further stores electronic receipts 108. In the example of FIG. 2, the memory area 204 stores the electronic receipts 108 associated with customers of the merchant 102 associated with the merchant computing device 202.

In general, the memory area 204 is associated with the merchant computing device 202. For example, in FIG. 2, the memory area 204 is within the merchant computing device 202. However, the memory area 204 or any of the data stored thereon may be associated with any server or other computer, local or remote from the merchant computing device 202 (e.g., accessible via a network).

The memory area 204, or one or more computer-readable media, further stores computer-executable components for implementing aspects of the disclosure. Exemplary components include a digest component 212, a status component 214, a publication component 216, and a revision component 218. The digest component 212 generates digitally signed electronic receipts 108 for delivery to the users 104 involved in transactions with the merchant 102 associated with the merchant computing device 202. For example, the generated electronic receipt 108 includes a customer identifier, an item identifier, a merchant identifier, and a transaction identifier. The merchant identifier includes any data identifying the merchant 102 such as, for example, a public key certificate associated with the merchant 102 or other identity that can be used to resolve a certificate. The certificate is used to validate the receipts 110 presented by the user 104. The item identifier includes any data identifying the item, such as a stock keeping unit (SKU), International Standard Book Number (ISBN), manufacturer-assigned identifier, or other globally unique identifier.

In some embodiments, the electronic receipts 108 include provable mapping information from the merchant identifier to the customer identifier.

The status component 214 maintains the list of cancelled transactions 208 between the users 104 and the plurality of merchants 102. For example, the status component 214 receives identification of cancelled transactions and adds the identified cancelled transactions to the list of cancelled transactions 208. The publication component 216 provides the list of cancelled transactions 208 for access by the merchants 102. In some embodiments, the list of cancelled transactions 208 includes a list of transactions and a plurality of status values corresponding thereto. Each of the plurality of status values indicates whether the corresponding transaction has been cancelled. The status component 214 modifies the status values to indicate whether particular transactions have been cancelled.

The merchants 102 access the list of cancelled transactions 208 to validate one or more of the electronic receipts 110 from the users 104. For example, a first one of the merchants 102 receives a request from one of the users 104 to obtain another copy of digital content previously purchased by the user 104 from a second one of the merchants 102. The user 104 digitally signs the electronic receipt 110 associated with the previous purchase, and presents the electronic receipt 110 to the first one of the merchants 102. The first one of the merchants 102 checks the list of cancelled transactions 208 of the second one of the merchants 102 to verify that the user 104 has not cancelled the transaction with the second one of the merchants 102 (e.g., the transaction has not been revoked, returned, exchanged, or the like). If the transaction has been cancelled, the first one of the merchants 102 may refuse the request from the user 104. If the transaction has not been cancelled, the first one of the merchants 102 may provide another copy of the digital content as requested.

In some embodiments, one or more of the electronic receipts 108 have included thereon an expiration date or other time period during which cancellation of the corresponding transactions is available (e.g., a time limit for returns or exchanges). In this manner, the electronic receipts 108 are marked or otherwise configured to include the expiration date, cancellation policy, etc. The cancellation policy may include, for example, a return policy, an exchange policy, or a refund policy.

The revision component 218 updates the electronic receipts 108 after the expiration date if the transaction has not been cancelled. For example, when the expiration date expires or lapses for a particular one of the electronic receipts 108, the revision component 218 compares the transaction to the list of cancelled transactions 208 (e.g., searches for the transaction on the list 208). If the transaction is on the list 208, the transaction has been cancelled. If the transaction is not on the list 208, the digest component 212 generates an updated electronic receipt 108 for the transaction that does not include the expiration date, policy, etc. The electronic receipt 108 is then provided to the user 104. The original electronic receipt 108 is discarded, deleted, or the like.

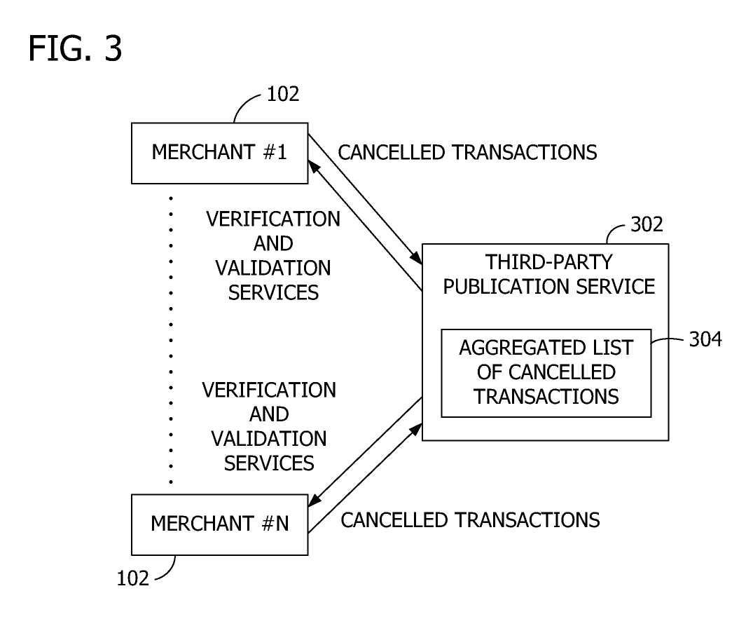

In some embodiments, the publication component 216 provides the list of cancelled transactions 208 to a third-party service such as described below with reference to FIG. 3.

Referring next to FIG. 3, an exemplary block diagram illustrates a third-party publication service 302 providing an aggregated list of cancelled transactions 304. In the example of FIG. 3, the publication service 302 receives cancelled transactions from the merchants 102 and adds them to the aggregated list 304. The merchants 102 interact with the publication service 302 to verify or validate the electronic receipts 110. In some embodiments, one of the merchants 102 provides a query for one or more of the transactions to the publication service 302. The publication service 302 searches the aggregated list 304 for the transactions in question and provides the status of the transactions to the merchant 102 or otherwise notifies the merchant 102 of the status. For example, the merchants 102 verify purchase of a song downloaded by one of the users 104, or otherwise validate one of the electronic receipts 110 provided by the user 104.

In some embodiments, the publication service 302 is one of the merchants 102 that aggregates the cancelled transactions from the other merchants 102.

Because the aggregated list 304 stored by the publication service 302 and the list of cancelled transactions 208 stored by each of the merchants 102 are publicly available lists 304,208, the lists 304,208 do not identify the users 104 directly. Rather, the lists 304,208 include transaction identifiers.

Referring next to FIG. 4, an exemplary flow chart illustrates the generation of the digitally signed electronic receipts 108 for transactions. The operations illustrated in FIG. 4 are performed by the merchant 102, or an entity associated with the merchant 102. If notification or indication of a transaction involved one of the digital content products is received at 402, the merchant 102 creates and digitally signs the electronic receipt 108 corresponding to the transaction at 404. The signed electronic receipt 108 is provided at 406 to the customer for storage. The customer merges the signed electronic receipt 108 with any other electronic receipts 110 associated with the customer (e.g., but from other merchants 102). In some embodiments, the electronic receipts 108 are provided from the merchant 102 to the customer over an encrypted channel.

In some embodiments, the customer stores the electronic receipts 110 on a memory area local to the customer (e.g., compact disc, digital versatile disc, flash memory, etc.). Alternatively or in addition, the customer stores or replicates the electronic receipts 110 via a cloud service, mesh service, or other networked storage area. In this manner, the customer is able to view the electronic receipts 110 from any computing device. Additionally, if the customer deletes or loses any of the electronic receipts 110 from a local memory area, the user 104 can request copies of the electronic receipts 110 from the networked storage area.

Similarly, the user 104 may also request copies of the electronic receipts 108 maintained for the user 104 by any of the merchants 102. The user 104 recreates the digital receipts booklet by re-authenticating with the merchants 102 and downloading the electronic receipts 108 from the merchants 102. The user 104 merges the received electronic receipts 108 into the electronic receipts 110. The merge capability also allows the user 104 to merge receipts 108 from one of the merchants 102 that starts exposing purchase history after transactions have already occurred (e.g., the merchant 102 begins offering the electronic receipt feature).

Referring next to FIG. 5, an exemplary flow chart illustrates the maintenance and publication of the list of cancelled transactions 208. The operations illustrated in FIG. 5 are performed by the merchant 102, or an entity associated with the merchant 102. If one of the merchants 102 receives a cancellation request (e.g., from one of the customers of the merchant 102) at 502, the merchant 102 cancels the transaction and updates the list of cancelled transactions 208 at 504. For example, the merchant 102 adds the transaction to the list of cancelled transactions 208. The merchant 102 publishes, or otherwise makes available, the list of cancelled transactions 208 at 506.

### EXAMPLES

The electronic receipts 110 stored by the users 104 may also be used as a form of digital rights management to enable functionality with an application program. In an example, the user 104 purchases and downloads a movie from one of the merchants 102 via a network such as the Internet. The user 104 receives the electronic receipt 108 corresponding to the purchase. When the user 104 attempts to play the movie in an application program, the application program searches for the electronic receipt 110 prior to playing the movie and validates the electronic receipt 110 via the publication service 302. The application program also validates the electronic receipt 110 via the digital signature from the merchant 102 on the electronic receipt 110.

In the above example, the user 104 does not need to be online or otherwise connected to a network to validate the electronic receipt 110. The application program may regularly or periodically obtain and store the aggregated list of cancelled transactions 304 from the publication service 302 in anticipation of being disconnected from the network.

In another example, a digital content producer is offering a buy two, get one free promotion. The user 104 purchases one offering from a first one of the merchants 102 and another offering from a second one of the merchants 102. The user 104 receives the electronic receipts 108 corresponding to their transactions from each of the merchants 102. The user 104 is able, using aspects of the disclosure, to visit any of the merchants 102 to receive the free offering under the promotion. The user 104 presents the electronic receipts 110 from the first two transactions as a proof-of-purchase.

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for generating the electronic receipts 108, exemplary means for maintaining the list of cancelled transactions 208, and exemplary means for implementing a decentralized account digest using the electronic receipts 108,110 and the list of cancelled transactions 208.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for generating electronic receipts and maintaining a list of cancelled transactions in association with a decentralized account digest, said system comprising:
a memory area for storing a list of cancelled transactions, said list of cancelled transactions being associated with a plurality of customers; and
a processor programmed to:
receive notification of a transaction relating to a digital content product, said transaction occurring between one of the plurality of customers and one or more merchants;
create and digitally sign an electronic receipt corresponding to the transaction;
provide the signed receipt to said one of the plurality of customers, wherein said one of the plurality of customers merges the signed receipt into a list of transactions associated with said one of the plurality of customers, said list including transactions between said one of the plurality of customers and a plurality of the merchants, wherein said one of the plurality of customers further distributes the signed receipt to one or more networked storage areas;
receive a request to cancel the transaction;
update the list of cancelled transactions in the memory area based on the received request; and
provide the list of cancelled transactions for access by the merchants, wherein the merchants access the list of cancelled transactions to validate one or more of the list of transactions.

2. The system of claim 1, wherein the signed receipt includes a customer identifier, an item identifier, a merchant identifier, and a transaction identifier.

3. The system of claim 2, wherein the merchant identifier includes a public key certificate.

4. The system of claim 2, wherein the item identifier is globally unique.

5. The system of claim 1, wherein the signed receipt includes notification of a return policy.

6. The system of claim 1, wherein the list of cancelled transactions includes a list of transactions and a plurality of status values corresponding thereto, wherein each of the plurality of status values indicate whether the corresponding transaction has been cancelled.

7. The system of claim 1, where the digital content product comprises one or more of the following: an electronic document, audio, video, and a still image.

8. The system of claim 1, further comprising:
means for generating the electronic receipts; and
means for maintaining the list of cancelled transactions.

9. The system of claim 1, further comprising means for implementing a decentralized account digest using the electronic receipts and the list of cancelled transactions.

10. A method of decentralizing storage of electronic receipts, said method comprising:
generating, by one of a plurality of merchants, digitally signed electronic receipts to users responsive to transactions between said one of the plurality of merchants and the users, said transactions relating to digital content products;
maintaining a list of cancelled transactions between the users and the plurality of merchants; and
providing the list of cancelled transactions for access by the plurality of merchants, wherein the plurality of merchants access the list of cancelled transactions to validate one or more of the electronic receipts.

11. The method of claim 10, wherein providing the list of cancelled transactions comprises transmitting the list of cancelled transactions to a third-party publication service for access by the plurality of merchants.

12. The method of claim 10, further comprising receiving a request from one of the plurality of merchants to validate one or more of the electronic receipts.

13. The method of claim 12, further comprising searching the list of cancelled transactions for said one or more of the electronic receipts, and notifying said one of the plurality of merchants based on said searching.

14. The method of claim 10, wherein maintaining the list of cancelled transactions comprises updating a plurality of status values each associated with one of the cancelled transactions, wherein said updating occurs responsive to notification of said one of the cancelled transactions.

15. The method of claim 10, further comprising:
receiving a request from one of the users for the electronic receipts associated with said one of the users;
re-generating, responsive to the received request, the electronic receipts associated with said one of the users; and
providing the re-generated electronic receipts to said one of the users.

16. The method of claim 10, further comprising:
receiving, from another of the plurality of merchants, another list of cancelled transactions;
merging the other list of cancelled transactions with the list of cancelled transactions; and
providing the merged list for access by the plurality of merchants.

17. One or more computer-readable media having computer-executable components, said components comprising:
a digest component that when executed by at least one processor causes the at least one processor to generate, by one of a plurality of merchants, digitally signed electronic receipts for delivery to users, said electronic receipts being associated with transactions between said one of the plurality of merchants and the users, wherein one or more of the electronic receipts have an expiration date associated therewith;
a status component that when executed by at least one processor causes the at least one processor to maintain a list of cancelled transactions between the users and the plurality of merchants;
a publication component that when executed by at least one processor causes the at least one processor to provide the list of cancelled transactions for access by the plurality of merchants, wherein the plurality of merchants access the list of cancelled transactions to validate one or more of the electronic receipts; and
a revision component that when executed by at least one processor causes the at least one processor to compare, when the one or more of the electronic receipts expire based on the expiration date, the associated transactions to the list of cancelled transactions to determine whether the transactions have been cancelled, wherein the digest component further generates, based on the comparison by the revision component, updated electronic receipts without the expiration date for delivery to the users.

18. The computer-readable media of claim 17, wherein the digest component generates the electronic receipts to have the expiration date based on a cancellation policy, said cancellation policy comprising one or more of the following: a return policy, an exchange policy, and a refund policy.

19. The computer-readable media of claim 17, wherein the publication component provides the list of cancelled transactions by publishing the list of cancelled transactions to a third-party service.

20. The computer-readable media of claim 17, wherein the status component maintains the list of cancelled transactions by receiving identification of cancelled transactions and adding the identified cancelled transactions to the list of cancelled transactions.
